(19) United States
(12) Patent Application Publication
(10) Pub. No.: US 2009/0301829 A1
(43) Pub. Date: Dec. 10, 2009

(54) METHOD FOR USING AN ELECTROMAGNETIC RETARDER

(76) Inventors: Serge Newiadomy, Clichy Sous Bois (FR); Mamy Rakotovao, Le Kremelin Bicetre (FR); Bruno Dessirier, Saint Germain en Laye (FR)

Correspondence Address: BERENATO & WHITE, LLC, 6550 ROCK SPRING DRIVE, SUITE 240, BETHESDA, MD, 20817, US

(21) Appl. No.: 12/092,136

(22) PCT Filed: Dec. 11, 2006
(86) PCT No.: PCT/FR2006/002701

§ 371 Date: Nov. 25, 2008

(30) Foreign Application Priority Data
Dec. 9, 2005 (FR) 055381.9

(51) Int. Cl. F16F 15/03

(52) U.S. Cl. 188/267

(57) ABSTRACT

A method for using an electromagnetic retarder of the type that comprises a current generator. The method relates to an electromagnetic retarder including a stator bearing the primary coils (8) of a current generator and a rotary shaft (7) bearing the secondary windings (5) of the generator and field coils (13) which are electrically powered by the secondary coils (5) via a current rectifier (15) borne by the rotary shaft (7). The method consists in injecting a direct current into the primary coils (8), the direct current having an intensity that increases gradually up to a nominal value over a pre-determined minimum period. The method is suitable for electromagnetic retarders which are intended for vehicles such as trucks.

### FIELD OF THE INVENTION

The invention concerns a method of controlling an electromagnetic retarder comprising a current generator. The invention also concerns such an electromagnetic retarder.

The invention applies to a retarder capable of generating a retarding resisting torque on a main or secondary transmission shaft of a vehicle that it equips, when this retarder is actuated.

### PRIOR ART

Such an electromagnetic retarder comprises a rotary shaft that is coupled to the main or secondary transmission shaft of the vehicle in order to exert on it the retarding resisting torque in particular for assisting the braking of the vehicle.

The retarding is generated with field coils supplied with DC current in order to produce a magnetic field in a metal piece made from ferromagnetic material, in order to make eddy currents appear in this metal piece.

The field coils can be fixed so as to cooperate with at least one metal piece made from movable ferromagnetic material having the general appearance of a disc rigidly secured to the rotary shaft.

In this case, these field coils are generally oriented parallel to the rotation axis and disposed around this axis, facing the disc, while being secured to a fixed plate. Two successive field coils are supplied electrically in order to generate magnetic fields in opposite directions.

When these field coils are supplied electrically, the eddy currents that they generate in the disc through their effects oppose the cause that gave rise to them, which produces a resisting torque on the disc and therefore on the rotary shaft, in order to slow down the vehicle.

In this embodiment, the field coils are supplied electrically by a current coming from the electrical system of the vehicle, that is to say for example from a battery of the vehicle. However, in order to increase the performance of the retarder, recourse is had to a design in which a current generator is integrated in the retarder.

Thus, according to another design known from the patent documents EP0331559 and FR1467310, the electrical supply to the field coils is provided by a generator comprising primary stator coils supplied by the vehicle system, and secondary rotor coils fixed to the rotating shaft. The field coils are secured to the rotating shaft while being radially projecting, in order to generate a magnetic field in a fixed cylindrical jacket that surrounds them.

A rectifier such as a diode bridge rectifier is interposed between the secondary rotor windings and the field coils, while also being carried by the rotary shaft. This rectifier converts the alternating current delivered by the secondary windings of the generator into DC currents supplying the field coils.

Two radial field coils consecutive around the rotation axis generate magnetic fields in opposite directions, one generating a field oriented centrifugally, the other a field oriented centripetally.

In operation, the electrical supply to the primary coils enables the generator to produce the supply current to the field coils, which gives rise to eddy currents in the fixed cylindrical jacket so as to generate a resisting torque on the rotary shaft, which slows the vehicle.

In order to reduce the weight and increase further the performance of such a retarder, it is advantageous to couple it to the transmission shaft of the vehicle by means of a speed multiplier, in accordance with the solution adopted in the patent document EP1527509.

The rotation speed of the retarder shaft is then multiplied compared with the rotation speed of the transmission shaft to which it is coupled. This arrangement significantly increases the electrical power delivered by the generator and therefore the power of the retarder.

A retarder of this type is for example controlled by means of a lever or the like able to be actuated directly by an occupant of the vehicle. The triggering of the retarder thus consists of moving the lever in question towards an activation position.

When the lever is in the activation position, a continuous excitation current is injected into the primary coils, which has the effect of exerting a braking torque on the rotary shaft as long as this excitation current is established in the primary coils.

The aim of the invention is to propose a method of operating such a retarder enabling its reliability and longevity to be increased.

### OBJECT OF THE INVENTION

To this end, an object of the invention is a method of operating an electromagnetic retarder comprising a current generator, consisting of establishing an excitation current in primary stator coils of this generator, this excitation current being injected from a control box connected to an electrical supply source, this electromagnetic retarder comprising a rotary shaft carrying secondary windings of the generator and field coils as well as a current rectifier, the field coils being supplied by the secondary coils via the rectifier, and in which the secondary windings have a time constant that is less than the time constant of the field coils and/or greater than the time constant of the primary coils, this method consisting of injecting into the primary coils a continuous excitation current having an intensity that increases progressively up to a nominal value for a predetermined minimum period.

On operation, the progressive increase in the excitation current for the primary coils makes it possible to limit the overvoltage consequent upon the transient effect due to the establishment of the currents in the electrical components situated downstream of these primary coils.

The reduction in this overvoltage by virtue of the current ramp on operation makes it possible in particular to preserve the rectifier, which comprises components sensitive to the high voltages consequent on the transient effect.

The invention also concerns a method as defined above, in which the predetermined minimum period is greater than the time constant of the primary coils, the time constant of the secondary windings and the time constant of the field coils.

The invention also concerns a method as defined above, consisting of making the excitation current increase in a linear fashion for the predetermined minimum period.

The invention also concerns the application of the method as defined above, to a rectifier in which the rectifying device is a diode bridge.

The invention also concerns an electromagnetic retarder comprising a current generator and a control box intended to be connected to an electrical supply source in order to electrically supply primary stator coils of this generator, this electromagnetic retarder comprising a rotary shaft carrying secondary windings of the generator and field coils as well as a current rectifier, the field coils being supplied by the secondary coils via the rectifier, in which the secondary windings have a time constant less that the time constant of the field coils and/or greater than the time constant of the primary coils, and in which the control box comprises means for injecting into the primary coils a continuous excitation current having an intensity that increases progressively up to a nominal value for a predetermined minimum period.

The invention also concerns an electromagnetic retarder as defined above, in which the rectifier is a diode bridge.

### BRIEF DESCRIPTION OF THE DRAWINGS

The invention will now be described in more detail, and with reference to the accompanying drawings, which illustrate an embodiment thereof by way of non-limitative example.

FIG. 1 is an overall view with local cutaway of an electromagnetic retarder to which the invention applies;

FIG. 2 is a schematic representation of the electrical components of the retarder according to the invention.

### DESCRIPTION OF EMBODIMENTS OF THE INVENTION

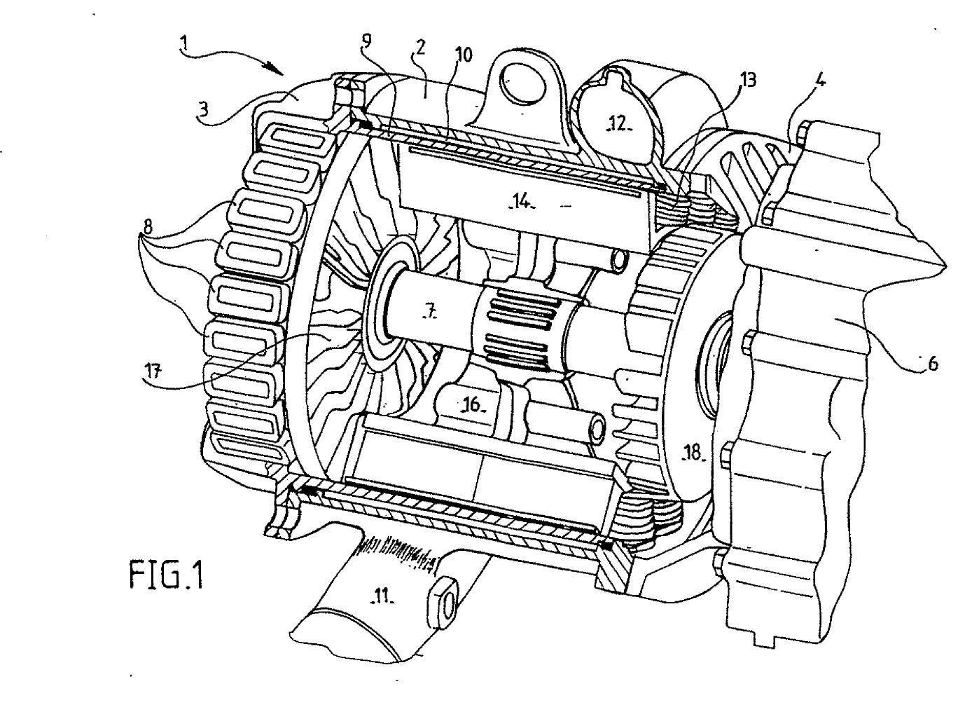

In FIG. 1, the electromagnetic retarder 1 comprises a main casing 2 with a cylindrical shape overall having a first end closed by a cover 3 and a second end closed by a coupling piece 4 by means of which this retarder 1 is fixed to a gearbox casing either directly or indirectly, here via a speed multiplier referenced 6.

This casing 2, which is fixed, encloses a rotary shaft 7 that is coupled to a transmission shaft, not visible in the figure, such as a main transmission shaft to the vehicle wheels, or secondary such as a secondary gearbox output shaft via the speed multiplier 6. In a region corresponding to the inside of the cover 3 a current generator is situated, which comprises fixed or stator primary coils 8 that surround rotor secondary windings, secured to the rotary shaft 7.

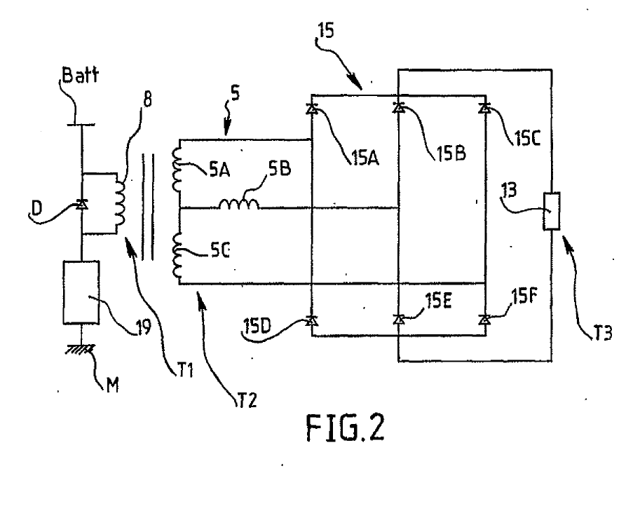

These secondary windings are shown symbolically in FIG. 2, being marked by the reference 5. These secondary windings 5 comprise here three distinct windings 5A, 5B and SC in order to deliver a three-phase alternating current having a frequency dependent on the speed of rotation of the rotary shaft 7.

An internal jacket 9, cylindrical in shape overall, is mounted in the main casing 2, being slightly spaced apart radially from the external wall of this main casing 2 in order to define a substantially cylindrical intermediate space 10 in which a cooling liquid of this jacket 9 circulates.

This main casing, which also has a cylindrical shape overall, is provided with a channel 11 for admitting cooling liquid into the space 10 and a channel 12 for discharging cooling liquid out of this space 10.

This jacket 9 surrounds several field coils 13, which are carried by a rotor 14 rigidly fixed to the rotary shaft 7. Each field coil 13 is oriented so as to generate a radial magnetic field while having an oblong shape overall extending parallel to the shaft 7.

In a known fashion, the jacket 9 and the body of the rotor 14 are made from ferromagnetic material. Here the casing is a castable piece based on aluminium and sealing joints intervene between the casing and jacket 9; the cover 3 and the piece 4 are perforated.

The field coils 13 are supplied electrically by the rotor secondary windings 5 of the generator via a bridge rectifier carried by the rotary shaft 7. This bridge rectifier can be the one that is marked 15 in FIG. 2 and that comprises six diodes 15A-15F, in order to rectify the three-phase alternating current issuing from the secondary windings 5A-5D into direct current. This bridge rectifier can also be of another type, being for example formed from transistors of the MOSFET type.

As can be seen in FIG. 1, the rotor 14 carrying the field coils 13 has the overall shape of a hollow cylinder connected to the rotary shaft 7 by radial arms 16. This rotor 14 thus defines an annular internal space situated around the shaft 7, this internal space being ventilated by an axial fan 17 situated substantially in line with the junction of the cover 3 with the casing 2. A radial fan 18 is situated at the opposite end of the casing 2 in order to discharge the air introduced by the fan 17.

The operation of the retarder consists of injecting into the primary coils 8 an excitation current coming from the electrical system of the vehicle and in particular the battery, so that the generator delivers a current at its secondary windings 5. This current supplies the field coils 13 in order to produce a resisting torque retarding the vehicle.

The excitation current is injected into the primary coils 8 by means of a control box 19, depicted in FIG. 2, which is interposed between an electrical supply source of the vehicle and the primary coils 8. In the example in FIG. 2 the control box 19 and the primary coils 8 are mounted in series between a mass M of the vehicle and a supply Batt of the vehicle battery. As can be seen in this figure, a diode D is mounted at the terminals of the primary coils 8 so as to prevent the circulation of a reverse current in the primary coils.

This control box 19 comprises an input able to receive a control signal representing a level of retarding torque demanded of the retarder.

This input can be connected to a lever or the like actuated directly by a driver of the vehicle. This lever may be able to move gradually between two extreme positions, namely a maximum position corresponding to a maximum resisting torque demand and a minimum position in which the retarder is not acted on.

When the driver places this lever in an intermediate position, the retarder is controlled by the box 19 in order to exert on the rotary shaft 7 a resisting torque proportional to the position of the lever, compared with the maximum retarding torque available. In other words, the input of the control box receives a control signal that corresponds to a value between zero and one hundred percent.

This input can also be connected to a braking control box that autonomously determines a control signal for the retarder. This braking control box is then connected to one or more braking actuators available to the driver. In this case, the driver does not act directly on the retarder but it is the braking control box that, using different parameters, controls the retarder and the traditional brakes of the vehicle.

The control box 19 is an electronic box comprising for example a logic circuit of the ASIC type functioning at 5V, and/or a power control circuit capable of managing currents of high intensity.

On reception of a control signal corresponding to a non-zero value, the control box 19 determines a nominal excitation current intensity to be injected into the primary coils 8, and injects into the primary coils 8 an excitation current whose intensity increases progressively until it reaches a nominal value. The box 19 next maintains this nominal intensity as long the control signal is unchanged, that is to say as long as a resisting torque is demanded of the retarder.

A progressive increase, for a predetermined period, of the intensity of the excitation current is for example effected in the form of a current ramp, that is to say a linear increase in the intensity until it reaches the nominal value.

This progressive increase in the intensity of the excitation current makes it possible to limit the overvoltages appearing during operation, at components situated downstream of the primary coils 8 that have longer reaction times than the primary coils 8. The longer the duration of establishment of the nominal intensity, the smaller the overvoltages.

In particular, when the time constants T1, T2 and T3 respectively of the primary coils 8, of the secondary windings 5 and of the field coils 13 do not satisfy the condition T1>T2>T3, the injection into the primary coils 8 of an excitation current that increases progressively up to a nominal value makes it possible to limit the overvoltages at the rectifier 15 when the retarder is operated.

For a retarder in which T2<T3, the time taken for the establishment of a current in the field coils 13 is greater than the time for establishing a current in the secondary windings 5. In the case of the injection of an excitation current step in the primary coils 8, the field coils 13 then behave like a bottleneck, which results in an overvoltage at the terminals of the rectifier 15.

According to the invention, when the retarder is operated, the control box 19 controls the excitation current so as to make it increase progressively up to a nominal value. This progressive increase in the intensity makes it possible to reduce the overvoltages at the terminals of the field coils and therefore at the terminals of the rectifier 15 each time the retarder is operated.

These overvoltages are the consequence of the transient current establishment regime when the retarder is operated. These overvoltages are the consequence of the transient current establishment regime, appearing in particular in the secondary windings when the retarder is operated.

Advantageously, the control box 19 controls a progressive increase in the intensity of the excitation current for a period that is greater than the time constant T1 of the secondary windings 5 and the time constant T3 of the field coils 13, so that no overvoltage appears at the terminals of the rectifier 15.

To limit also the overvoltage at the terminals of the primary coils 8, the duration of the progressive increase is also greater than the time constant T1 of the primary coils. Thus the predetermined period during which the control box makes the excitation current increase is advantageously a period that is greater than T1, T2 and T3 in order to ensure that no overvoltage appears in the retarder when it is operated.

This predetermined period must not be too great in order to keep satisfactory reactivity of the retarder when it is acted on. Advantageously, the predetermined period of establishing an excitation current is between one and ten times the longest time constant among T1, T2 and T3, which makes it possible both to limit overvoltages and to ensure correct reactivity when the retarder is acted on.

The progressive increase in the excitation current for the predetermined period can be controlled by the control box 19 so as to be linear, while corresponding to a current ramp.

This progressive increase in the intensity may also follow another change law of the continuously derivable type. For example, the excitation current can increase quadratically with respect to time, exponentially or indeed trigonometrically.

The overvoltage is in particular dependent on the slope of variation in the excitation current during operation. This progressive increase in intensity

The choice of an adapted change law makes it possible also to reduce the overvoltage at the terminals of the rectifier 15 so as to reduce the time taken for establishment of the current in order to bring it as close as possible to the longest time constant among T1, T2 and T3.

Advantageously, the intensity of the excitation current increases exponentially during operation, which makes it possible to bring the duration of establishment of the excitation current to a value very close to that of the longest time constant among T1, T2 and T3.

The invention thus limits the overvoltage at the terminals of the current rectifier, which reduces the manufacturing cost of the rectifier and increases its longevity.

In particular in the case of a current rectifier 15 with a diode bridge, as in the example in the figures, it is possible to use inexpensive diodes since such diodes have to withstand only a very small overvoltage.

One that the invention also makes it possible to avoid a deterioration in the field coils and/or the secondary windings of the generator by reducing the voltages applied to them.

Naturally the invention is not limited to the example embodiments described. It applies in particular to a retarder comprising a current rectifier in the form of a transistor bridge of the MOSFET type. The number of phases of the generator, which depends on the application, may be greater than three in a variant.

1. Method of operating an electromagnetic retarder (1) comprising a current generator, comprising the steps of establishing an excitation current in primary stator coils (8) of this generator, is said excitation current being injected from a control box (19) connected to an electrical supply source, said electromagnetic retarder (1) comprising a rotary shaft (7) carrying secondary windings (5) of the generator and field coils (13) as well as a current rectifier (15), the field coils (13) being supplied by the secondary coils (5) via the rectifier (15), and in which the secondary windings (5) have a time constant (T2) that is less than the time constant (T3) of the field coils (13) and/or greater than the time constant (T1) of the primary coils (8), said method further comprising the of injecting into the primary coils (8) a continuous excitation current having an intensity that increases progressively up to a nominal value for a predetermined minimum period.

2. Method according to claim 1, in which the predetermined minimum period is greater than the time constant (T1) of the primary coils (8), the time constant (T2) of the secondary windings (5) and the time constant (T3) of the field coils (13).

3. Method according to claim 1, consisting further comprising the step of making the excitation current increase in a linear fashion during the predetermined minimum period.

4. Application of the method according to claim 1 to a retarder (1) in which the rectifying device (15) is a diode bridge (15A-15F).

5. Electromagnetic retarder (1) comprising a current generator and a control box (19) intended to be connected to an electrical supply source in order to electrically supply primary stator coils (8) of this generator, said electromagnetic retarder comprising a rotary shaft (7) carrying secondary windings (5) of the generator and field coils (13) as well as a current rectifier (15), the field coils (13) being supplied by the secondary coils (5) via the rectifier (15), in which the secondary windings (5) have a time constant (T2) less that the time constant (T3) of the field coils (13) and/or greater than the time constant (T1) of the primary coils (8), and in which the control box comprises means for injecting into the primary coils (8) a continuous excitation current having an intensity that increases progressively up to a nominal value for a predetermined minimum period.

6. Retarder according to claim 5, in which the rectifier (15) is a diode bridge (15A-15F).
